(19) United States
(12) Patent Application Publication
(10) Pub. No.: US 2017/0251110 A1
(43) Pub. Date: Aug. 31, 2017

(54) COMMUNICATION DATA ACCOUNT PROCESSING METHOD AND DEVICE THEREOF

(71) Applicant: Alibaba Group Holding Limited, Grand Cayman (KY)

(72) Inventors: Hui Dong, Hangzhou (CN); Hui Qiang, Hangzhou (CN); Yangkai WU, Hangzhou (CN); Limin Guo, Hangzhou (CN); Jian Sun, Hangzhou (CN); Yi Shen, Hangzhou (CN)

(21) Appl. No.: 15/593,167

(22) Filed: May 11, 2017

Related U.S. Application Data
(63) Continuation of application No. PCT/CN2015/093630, filed on Nov. 3, 2015.

(30) Foreign Application Priority Data
Nov. 12, 2014 (CN) 201410635823.1

(51) Int. Cl. H04M 15/00; H04W 4/24

(52) U.S. Cl. CPC H04M 15/783; H04W 4/24; H04M 15/755; H04M 15/47

(57) ABSTRACT

A communication data account processing method is disclosed. The method includes: establishing a communication data account associated with a terminal user for the terminal user, and storing communication data resource information corresponding to the communication data account; receiving an operation instruction of the terminal user for the communication data account, the operation instruction including a mobile communication identifier; identifying a communication service provider corresponding to the mobile communication identifier; establishing a connection with a system interface of the communication service provider, and sending the mobile communication identifier and the operation instruction of the user to the system interface of the communication service provider; receiving response information of the system interface of the communication service provider; and performing an operation on the communication data account according to the response information. By using the present disclosure, a data allotment can be transferred conveniently without suffering any limitation due to an operator.

### CROSS REFERENCE TO RELATED PATENT APPLICATIONS

This application claims priority to and is a continuation of PCT Patent Application No. PCT/CN2015/093630, filed on 3 Nov. 2015, which claims priority to and is related to Chinese Patent Application No. 201410635823.1 filed on 12 Nov. 2014, entitled “Communication Traffic Account Processing Method and Device thereof,” which are hereby incorporated by reference in their entirety.

### TECHNICAL FIELD

The present disclosure relates to the field of communications, and in particular, to communication data account processing methods and apparatuses thereof.

### BACKGROUND

A service of remitting used communication data allotment for a user in a backward manner is currently available in the market. For example, a user may try to install and use an application (APP) promoted by the APP developer, all communication data usage that is generated during the usage of this application by a user is remitted via a communication operator at the end of a month. This type of remission method of data allotment has many deficiencies. For example, a user can only know that the data allotment associated with the use of an application is remitted, but cannot determine exactly an amount of the data allotment that is remitted. As such, the user cannot know a data usage condition since there is no reference for comparison. Moreover, this existing method makes settlement on the data allotment associated with a month at the end of that month, and a situation in which the remission is not timely may exist. In addition, data allotment remissions of some applications are limited to be available only in a specific communication operator, for example, only available in China Telecom. As a result, users of China Mobile and China Unicom cannot have their data allotment remitted.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the present disclosure is to provide a communication data account processing method and an apparatus thereof, which can perform a transfer of data allotment without suffering any limitation due to an operator in a convenient manner at any time and any place.

To solve the above technical problem, the present disclosure provides a communication data account processing method. Communication data resource information is updated according to an operation instruction. The method may include establishing a communication data account associated with a terminal user for the terminal user, and storing communication data resource information corresponding to the communication data account; receiving an operation instruction of the terminal user for the communication data account, the operation instruction including a mobile communication identifier; identifying a communication service provider corresponding to the mobile communication identifier; establishing a connection with a system interface of the communication service provider, and sending the mobile communication identifier and the operation instruction of the user to the system interface of the communication service provider; receiving response information of the system interface of the communication service provider; and performing an operation on the communication data account according to the response information.

In implementations, the present disclosure further provides a communication data account processing method. The method may include establishing a communication data account associated with a terminal user for the terminal user, and storing communication data resource information corresponding to the communication data account, the communication data resource information indicating a corresponding amount of a communication data allotment of the communication data account; receiving a communication data allotment modification instruction of the terminal user for the communication data account, the communication data allotment modification instruction including a communication data account associated with another terminal user and an amount of communication data allotment to be transferred to the communication data account associated with the other terminal user; and updating communication data resource information corresponding to the communication data account associated with the other terminal user according to the communication data allotment modification instruction.

In implementations, the present disclosure further provides a communication data account processing apparatus. The processing apparatus may include a data allotment storage unit establishing a communication data account associated with the terminal user for a terminal user, and storing communication data resource information corresponding to the communication data account; an instruction receiving unit receiving an operation instruction of the terminal user for the communication data account, the operation instruction including a mobile communication identifier; an identification unit identifying a communication service provider corresponding to the mobile communication identifier; an instruction sending unit establishing a connection with a system interface of the communication service provider, and sending the mobile communication identifier and the operation instruction of the user to the system interface of the communication service provider; a response receiving unit receiving response information of the system interface of the communication service provider; and an operation unit performing an operation on the communication data account according to the response information.

In implementations, the present disclosure further provides a communication data account processing apparatus. The processing apparatus may include a data allotment storage unit establishing a communication data account associated with the terminal user for a terminal user, and storing communication data resource information corresponding to the communication data account, the communication data resource information indicating an amount of a corresponding communication data allotment of the communication data account; an instruction receiving unit receiving a communication data allotment modification instruction of the terminal user for the communication data account, the communication data allotment modification instruction including a communication data account associated with another terminal user and an amount of communication data allotment to be transferred to the communication data account associated with the other terminal user; and a data allotment update unit updating communication data resource information corresponding to the communication data account associated with the other terminal user according to the communication data allotment modification instruction.

Compared with existing technologies, the embodiments of the present disclosure have the following differences and effects.

Since communication data resource information is updated based on an operation instruction of a terminal user, the time and the amount of the data allotment transferred may be freely controlled, and the transfer of the data allotment is made possible even under limitations of a communication operator.

Furthermore, the operation instruction may be verified to prevent malicious operations, thus improving the security.

Moreover, users may request to update communication data resource information for other users. Therefore, the users may freely control data allotments for either self-use or transfer as a gift.

### BRIEF DESCRIPTION OF THE DRAWINGS

FIG. 1 is a flowchart of a communication data account processing method according to a first embodiment of the present disclosure.

FIG. 2 is a flowchart of a communication data account processing method according to a second embodiment of the present disclosure.

FIG. 3 is a structural diagram of a communication data account processing apparatus according to a third embodiment of the present disclosure.

FIG. 4 is a structural diagram of a communication data account processing apparatus according to a fourth embodiment of the present disclosure.

### DETAILED DESCRIPTION

In the following description, a number of technical details are provided to help readers better understand the present application. However, one of ordinary skill in the art should understand that technical solutions covered by the claims of the present application can also be implemented with various variations and modifications that are based on the embodiments described herein.

To make the objectives, technical solutions, and advantages of the present disclosure more comprehensible, the embodiments of the present disclosure are further described in detail hereinafter with reference to the accompanying drawings.

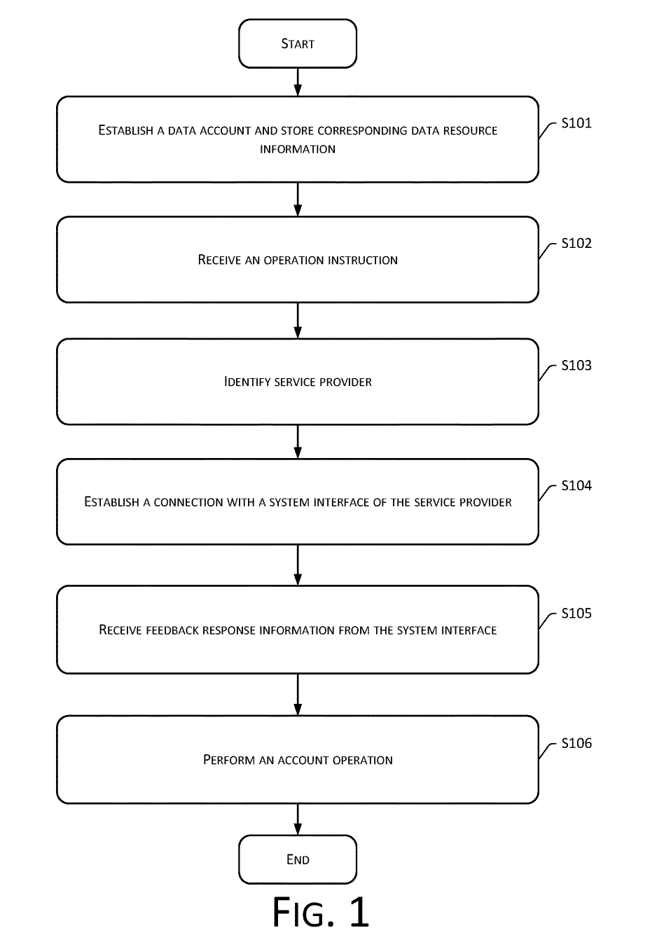

In implementations, the present disclosure provides a communication data account processing method 100. FIG. 1 shows a flowchart of the processing method 100.

In implementations, the processing method 100 may update communication data resource information according to an operation instruction. As shown in FIG. 1, the processing method 100 may include the following operations.

At S101, a communication data account associated with a terminal user is established for the terminal user, and communication data resource information corresponding to the communication data account is stored.

The communication data account may be established by an intermediary platform, for example, an e-commerce platform, which may be independent of various communication service providers.

At S102, an operation instruction of the terminal user for the communication data account is received. The operation instruction may include a mobile communication identifier. Different mobile communication identifiers may correspond to different communication service providers. Different communication service providers separately establish corresponding account systems according to the mobile communication identifier.

In implementations, the operation instruction of the terminal user may include transferring a communication data allotment in the communication data account of the terminal user on the intermediary platform to an account in an account system of a communication service provider that corresponds to the mobile communication identifier provided by the terminal user.

At S103, a communication service provider corresponding to the mobile communication identifier is identified. For example, a communication service provider may generally set an access code of a mobile communication service at a designated character position of the mobile communication identifier. Therefore, a communication service provider corresponding to the mobile communication identifier is identified based on an access code in the mobile communication identifier.

At S104, a connection is established with a system interface of the communication service provider, and the mobile communication identifier and the operation instruction of the user are sent to the system interface of the communication service provider. The current operation ensures that every service provider has a dedicated system interface for sending, without suffering any limitation. For example, if the service provider is China Mobile, a dedicated system interface provided by China Mobile is used for performing an operation. If the service provider is China Unicom or China Telecom, a similar operation is performed.

At S105, response information of the system interface of the communication service provider is received.

At S106, an operation is performed on the communication data account according to the response information.

The process is ended.

In implementations, the operation on the communication data account at S106 may include updating communication data resource information corresponding to the communication data account. The communication data resource information may include a size of a communication data allotment of the communication data account corresponding to the terminal user. However, the present disclosure is not limited thereto, and other operations may also be performed.

In implementations, the operation instruction further may include information of an amount of a communication data allotment to be transferred. The information of the amount of the communication data allotment to be transferred may include an amount of a communication data allotment to be transferred to an account in an account system of the communication service provider corresponding to the mobile communication identifier. The information of the amount of the communication data allotment to be transferred may be used to be compared with the communication data resource information corresponding to the communication data account to determine whether a transfer of the data allotment is feasible. For example, if an amount of a communication data allotment to be transferred is 50 M, but the communication data resource information corresponding to the communication data account shows that the data allotment is only 10 M, being less than the 50 M data allotment to be transferred. In this case, the transfer cannot be implemented apparently. However, the present disclosure is not limited thereto, and may also be implemented even without information of an amount of a communication data allotment to be transferred.

In implementations, the operation instruction may further include verification information. The verification information is used for verifying the operation instruction. A variety of verification methods are applicable to the present disclosure, for example, sending a verification code to a mobile phone, sending a verification link to an electronic mail box, directly displaying a verification picture, and the like. Verifying the operation instruction can prevent malicious operations and improve the security. However, the present disclosure is not limited thereto, and may also be implemented even without the verification operation of the operation instruction.

In implementations, the processing method may further include: receiving a communication data allotment modification instruction sent by a third-party user, the communication data allotment modification instruction including a communication data account associated with a specific terminal user and an amount of a communication data allotment to be transferred to the communication data account associated with the specific terminal user; and updating communication data resource information corresponding to the communication data account associated with the specific terminal user according to the communication data allotment modification instruction (not shown). A variety of methods exist for a third-party user to send a communication data allotment modification instruction. For example, if the third-party user is a merchant, the merchant sends the instruction to increase a communication data allotment for the user after a transaction operation of the user with the merchant is successful. However, the present disclosure is not limited thereto, and other operations such as accesses and comments are also feasible, in addition to transaction.

Various method embodiments of the present disclosure can all be implemented in a form of software, hardware, firmware, or the like. For example, the example methods may be implemented by one or more computing devices. No matter whether the present disclosure is implemented in a form of software, hardware, or firmware, an instruction code can be stored in any type of computer accessible storage device (e.g., permanent or modifiable, volatile or non-volatile, solid-state or non-solid-state, fixed or replaceable media, etc.). Similarly, a storage device may be, for example, a Programmable Array Logic (PLA), a Random Access Memory (RAM), a Programmable Read Only Memory (PROM), a Read-Only Memory (ROM), an Electrically Erasable Programmable ROM (EEPROM), a magnetic disk, an optical disc, a Digital Versatile Disc (DVD), etc.

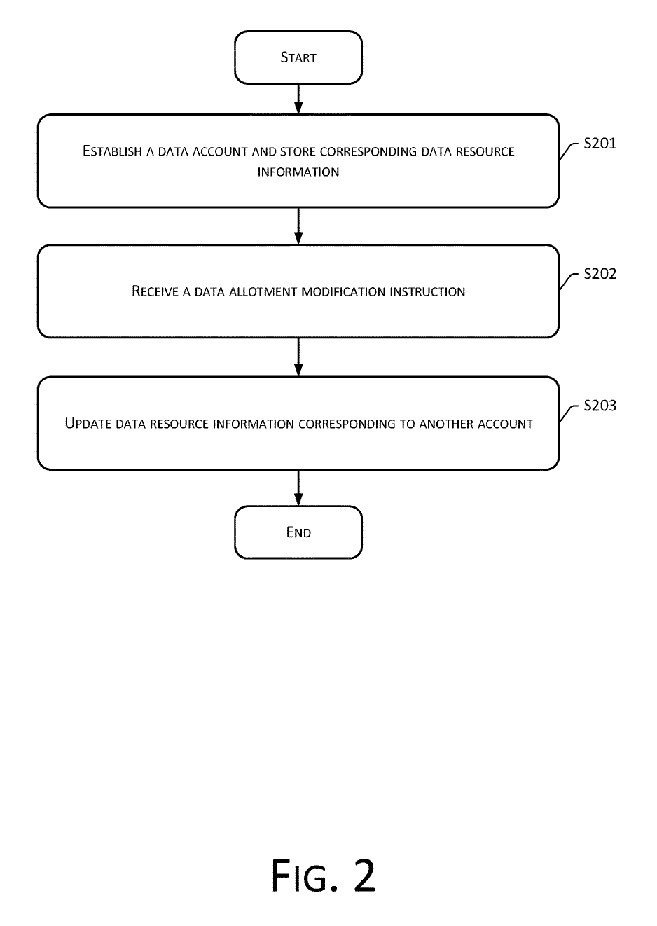

In implementations, the present disclosure further provides a communication data account processing method 200. FIG. 2 shows a flowchart of the processing method 200.

Specifically, an operation similar to “recharging” is performed in the first example method 100. The second example method 200 is substantially similar to the first example method 100, and performs an operation similar to “giving”. As shown in FIG. 2, the processing method 200 may include the following operations.

At S201, a communication data account associated with a terminal user is established for the terminal user, and communication data resource information corresponding to the communication data account is stored. The communication data resource information indicates a size of a corresponding communication data allotment of the communication data account.

At S202, a communication data allotment modification instruction of the terminal user for the communication data account is received. The communication data allotment modification instruction includes a communication data account associated with another terminal user and an amount of a communication data allotment to be transferred to the communication data account associated with the other terminal user.

At S203, communication data resource information corresponding to the communication data account associated with the other terminal user is updated according to the communication data allotment modification instruction.

The process is ended.

In order to facilitate understanding, an instance of operations according to the above operations is provided herein. In this instance, after a terminal user performs transaction with a merchant which acts as a third-party user, the merchant sends a communication data allotment modification instruction. It is understandable that this instance is merely an example. The present disclosure is not limited thereto, and may also be applicable to other cases.

After accessing the merchant through a web page or a mobile phone application (APP), the terminal user performs transaction on the merchant. After confirming that the transaction is successful, the merchant sends a communication data allotment modification instruction to increase a communication data allotment for the user (for example, calling an API/SDK of a corresponding platform). A platform delivers a data allotment to a communication data account associated with the user according to the communication data allotment modification instruction. According to actual requirements, the user may perform a “recharging” operation or a “giving” operation on the data allotment in the communication data account. In an event of “recharging” operation, as the operation may be performed by selecting a dedicated interface corresponding to a communication model provider according to a mobile communication model of a terminal device, the terminal device (such as a smart phone) of the user can perform “recharging” in any communication model, without suffering any limitation. In an event of “giving” operation, a terminal user may increase a communication data allotment for another terminal user by sending a communication data allotment modification instruction.

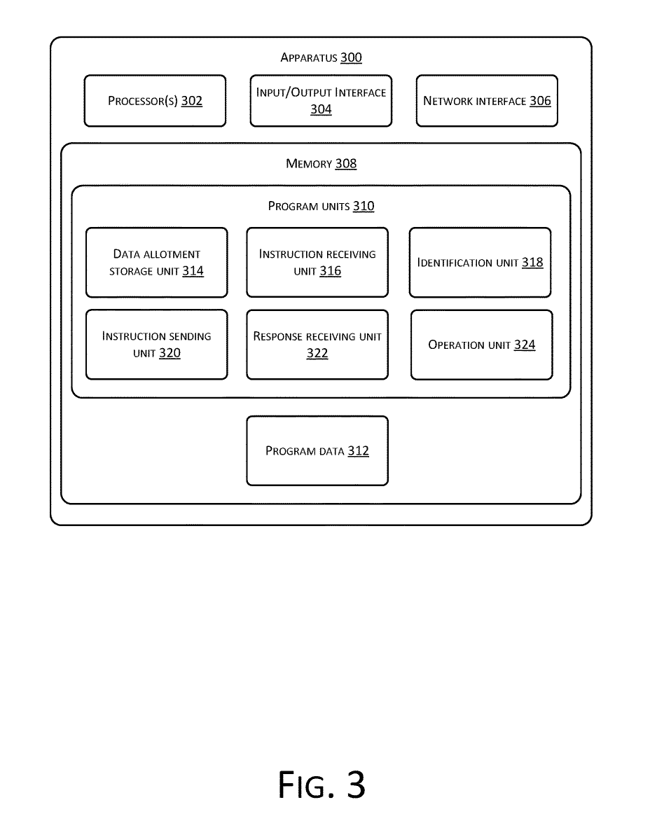

In implementations, the present disclosure further provides a communication data account processing apparatus 300. FIG. 3 shows a structural diagram of the communication data account processing apparatus 300. An actual structure of the present disclosure may be made with necessary adjustments according to actual requirements, and is not limited to the structure in FIG. 3.

Specifically, the processing apparatus 300 may update communication data resource information according to an operation instruction. As shown in FIG. 3, the processing apparatus 300 may include one or more processors 302, an input/output (I/O) interface 304, a network interface 306, and memory 308.

The memory 308 may include a form of computer-readable media, e.g., a non-permanent storage device, random-access memory (RAM) and/or a nonvolatile internal storage, such as read-only memory (ROM) or flash RAM. The memory 308 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

In implementations, the memory 308 may include program units 310 and program data 312. The program units 310 may include a data allotment storage unit 314 configured to establish a communication data account associated with a terminal user for the terminal user, and store communication data resource information corresponding to the communication data account; an instruction receiving unit 316 configured to receive an operation instruction of the terminal user for the communication data account, the operation instruction including a mobile communication identifier; an identification unit 318 configured to identify a communication service provider corresponding to the mobile communication identifier; an instruction sending unit 320 configured to establish a connection with a system interface of the communication service provider, and send the mobile communication identifier and the operation instruction of the user to the system interface of the communication service provider; a response receiving unit 322 configured to receive response information of the system interface of the communication service provider; and an operation unit 324 configured to perform an operation on the communication data account according to the response information.

The first example method 100 is a method embodiment corresponding to the present embodiment, and the present embodiment may be implemented in conjunction with the first embodiment. Related technical details mentioned in the first example method 100 are still effective in this embodiment, which are not repeatedly described herein in order to avoid redundancies. Correspondingly, related technical details mentioned in the present embodiment are also applicable to the first example method 100.

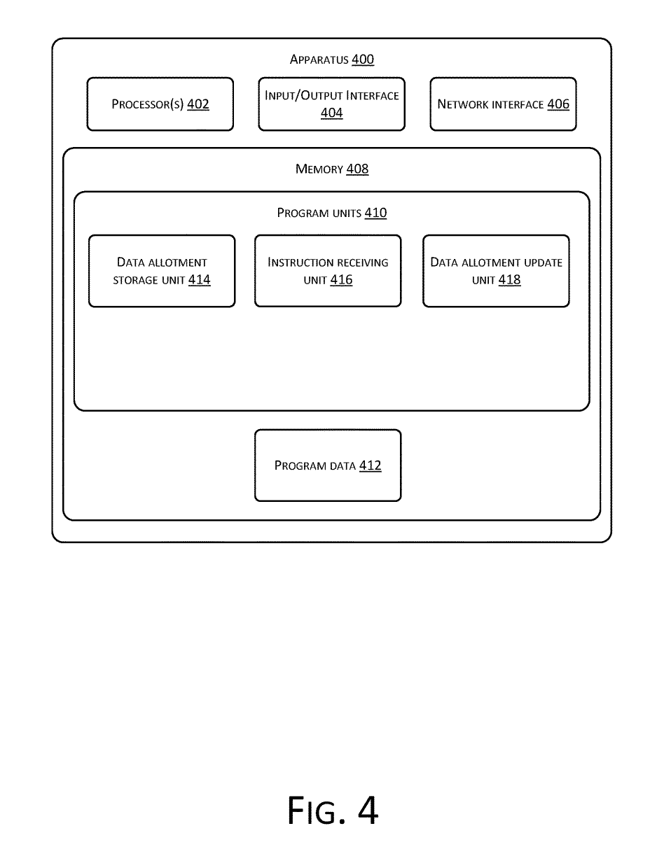

In implementations, the present disclosure further provides another communication data account processing apparatus 400. FIG. 4 shows a structural diagram of the communication data account processing apparatus 400. An actual structure of the present disclosure may be made with necessary adjustments according to actual requirements, and is not limited to the structure in FIG. 4.

Specifically, the processing apparatus 400 may update communication data resource information according to an operation instruction. As shown in FIG. 4, the processing apparatus 400 may include one or more processors 402, an input/output (I/O) interface 404, a network interface 406, and memory 408. The memory 408 is an example of computer-readable media as described in the foregoing description.

In implementations, the memory 408 may include program units 410 and program data 412. The program units 410 may include a data allotment storage unit 414 configured to establish a communication data account associated with a terminal user for the terminal user, and store communication data resource information corresponding to the communication data account, the communication data resource information indicating a size of a corresponding communication data allotment of the communication data account; an instruction receiving unit 416 configured to receive a communication data allotment modification instruction of the terminal user for the communication data account, the communication data allotment modification instruction including a communication data account associated with another terminal user and an amount of a communication data allotment to be transferred to the communication data account associated with the other terminal user; and a data allotment update unit 418 configured to update communication data resource information corresponding to the communication data account associated with the other terminal user according to the communication data allotment modification instruction.

The second example method 200 is a method embodiment corresponding to the present embodiment, and the present embodiment may be implemented in conjunction with the second embodiment. Related technical details mentioned in the second example method 200 are still effective in the present embodiment, which are not repeatedly described herein in order to avoid redundancies. Correspondingly, related technical details mentioned in the present embodiment are also applicable to the second example method 200.

It should be noted that various units mentioned in the apparatus embodiments of the present disclosure are all logic units. Physically, a logic unit may be a physical unit, or a part of a physical unit, and may also be implemented as a combination of a plurality of physical units. Physical embodiments of these logic units per se are not the most important, but a combination of functions implemented by these logic units is the key to solve the technical problem put forward in the present disclosure. In addition, in order to highlight innovative parts of the present disclosure, the apparatus embodiments of the present disclosure do not introduce units that are not too closely associated with solving the technical problem put forward in the present disclosure. This does not indicate that the apparatus embodiments do not have other units.

It should be noted that relational terms, such as first and second, etc., in the claims and the specification of the present application, are used merely to distinguish one entity or operation from another entity or operation without necessarily requiring or implying any such actual relationship or order between these entities or operations. Furthermore, terms “include”, “comprise” and any other variants thereof are intended to cover non-exclusive inclusion, so that a process, a method, an article or a device including a series of elements includes not only these elements, but also other elements not explicitly listed, or further includes inherent elements of the process, the method, the article or the device. Under a condition without further limitation, an element as defined by a statement “including a/an . . . ” does not exclude additional identical elements in the process, the method, the article or the device that includes this element.

Although the present disclosure has been illustrated and described with reference to above exemplary embodiments of the present disclosure, one of ordinary skill in the art should understand that various changes can be made thereto in forms and details without departing from the spirit and scope of the present disclosure.

What is claimed is:

1. A method implemented by one or more computing devices, the method comprising:
storing communication data resource information corresponding to a communication data account associated with a terminal user;
receiving an operation instruction of the terminal user for the communication data account, the operation instruction comprising a mobile communication identifier;
identifying a communication service provider corresponding to the mobile communication identifier;
sending the mobile communication identifier and the operation instruction of the user to a system interface of the communication service provider;
receiving response information of the system interface of the communication service provider; and
performing an operation on the communication data account according to the response information.

2. The method of claim 1, wherein performing the operation on the communication data account according to the response information includes updating the communication data resource information corresponding to the communication data account, the communication data resource information including a size of a communication data allotment of the communication data account associated with the terminal user.

3. The method of claim 1, wherein the operation instruction further comprises information of an amount of a communication data allotment to be transferred, the information of the amount of the communication data allotment to be transferred comprising an amount of a communication data allotment to be transmitted to an account in an account system of the communication service provider corresponding to the mobile communication identifier.

4. The method of claim 1, wherein the operation instruction further comprises verification information used for verifying the operation instruction.

5. The method of claim 1, further comprising receiving a communication data allotment modification instruction sent by a third-party user, the communication data allotment modification instruction comprising a communication data account associated with another terminal user and an amount of a communication data allotment to be transferred to the communication data account associated with the other terminal user.

6. The method of claim 5, further comprising updating communication data resource information corresponding to the communication data account associated with the other terminal user according to the communication data allotment modification instruction.

7. The method of claim 5, further comprising:
comparing the amount of the communication data allotment to be transferred with the communication data resource information to determine whether a transfer of the data allotment to the communication data account associated with the other terminal user is feasible; and
updating communication data resource information corresponding to the communication data account associated with the other terminal user according to the communication data allotment modification instruction upon determining that the transfer of the data allotment is feasible.

8. An apparatus comprising:
one or more processors;
memory;
a data allotment storage unit stored in the memory and executable by the one or more processors to store communication data resource information corresponding to a communication data account associated with a terminal user;
an instruction receiving unit stored in the memory and executable by the one or more processors to receive an operation instruction of the terminal user for the communication data account, the operation instruction comprising a mobile communication identifier;
an identification unit stored in the memory and executable by the one or more processors to identify a communication service provider corresponding to the mobile communication identifier;
an instruction sending unit stored in the memory and executable by the one or more processors to send the mobile communication identifier and the operation instruction of the user to a system interface of the communication service provider;
a response receiving unit stored in the memory and executable by the one or more processors to receive response information of the system interface of the communication service provider; and
an operation unit stored in the memory and executable by the one or more processors to perform an operation on the communication data account according to the response information.

9. The apparatus of claim 8, wherein performing the operation on the communication data account according to the response information includes updating the communication data resource information corresponding to the communication data account, the communication data resource information including a size of a communication data allotment of the communication data account associated with the terminal user.

10. The apparatus of claim 8, wherein the operation instruction further comprises information of an amount of a communication data allotment to be transferred, the information of the amount of the communication data allotment to be transferred comprising an amount of a communication data allotment to be transmitted to an account in an account system of the communication service provider corresponding to the mobile communication identifier.

11. The apparatus of claim 8, wherein the operation instruction further comprises verification information used for verifying the operation instruction.

12. The apparatus of claim 8, wherein the instruction receiving unit is further configured to receive a communication data allotment modification instruction sent by a third-party user, the communication data allotment modification instruction comprising a communication data account associated with another terminal user and an amount of a communication data allotment to be transferred to the communication data account associated with the other terminal user.

13. The apparatus of claim 12, further comprising a data allotment update unit to update communication data resource information corresponding to the communication data account associated with the other terminal user according to the communication data allotment modification instruction.

14. One or more computer-readable media storing executable instructions that, when executed by one or more processors, cause the one or more processors to perform acts comprising:
storing communication data resource information corresponding to a communication data account associated with a terminal user;
receiving an operation instruction of the terminal user for the communication data account, the operation instruction comprising a mobile communication identifier;
identifying a communication service provider corresponding to the mobile communication identifier;
sending the mobile communication identifier and the operation instruction of the user to a system interface of the communication service provider;
receiving response information of the system interface of the communication service provider; and
performing an operation on the communication data account according to the response information.

15. The one or more computer-readable media of claim 14, wherein performing the operation on the communication data account according to the response information includes updating the communication data resource information corresponding to the communication data account, the communication data resource information including a size of a communication data allotment of the communication data account associated with the terminal user.

16. The one or more computer-readable media of claim 14, wherein the operation instruction further comprises information of an amount of the communication data allotment to be transferred, the information of the amount of the communication data allotment to be transferred comprising an amount of the communication data allotment to be transmitted to an account in an account system of the communication service provider corresponding to the mobile communication identifier.

17. The one or more computer-readable media of claim 14, wherein the operation instruction further comprises verification information used for verifying the operation instruction.

18. The one or more computer-readable media of claim 14, the acts further comprising receiving a communication data allotment modification instruction sent by a third-party user, the communication data allotment modification instruction comprising a communication data account associated with another terminal user and an amount of a communication data allotment to be transferred to the communication data account associated with the other terminal user.

19. The one or more computer-readable media of claim 18, the acts further comprising updating communication data resource information corresponding to the communication data account associated with the other terminal user according to the communication data allotment modification instruction.

20. The one or more computer-readable media of claim 18, the acts further comprising:
comparing the amount of the communication data allotment to be transferred with the communication data resource information to determine whether a transfer of the data allotment to the communication data account associated with the other terminal user is feasible; and
updating communication data resource information corresponding to the communication data account associated with the other terminal user according to the communication data allotment modification instruction upon determining that the transfer of the data allotment is feasible.
